(19) United States
(12) Patent Application Publication
(10) Pub. No.: US 2018/0188988 A1
(43) Pub. Date: Jul. 5, 2018

(54) PARTIAL PAGE ACCESS IN A LOW POWER MEMORY SYSTEM

(71) Applicant: QUALCOMM Incorporated, San Diego, CA (US)

(72) Inventors: Nikhil JAIN, Dhuri (IN); Ankit SHAMBHU, Bangalore (IN); Umesh RAO, Bangalore (IN); Srinivasarao MOLA, Bangalore (IN)

(21) Appl. No.: 15/808,739

(22) Filed: Nov. 9, 2017

Related U.S. Application Data
(60) Provisional application No. 62/442,288, filed on Jan. 4, 2017.

(51) Int. Cl. G06F 3/06

(52) U.S. Cl. CPC G06F 3/0625; G06F 3/0673; G06F 3/0659; G06F 3/0634

(57) ABSTRACT

Systems and method are directed to reducing power consumption of a memory based on enabling partial page access. Based on system conditions such as operating frequency, access size for one or more memory access requests are determined. The access size is programmed in a mode register of the memory and one or more commands are issued for accessing the memory based on the programmed access size. Alternatively, the access sizes are specified within the one or more commands issued to the memory for accessing partial pages. Activating only the portion of a page corresponding to the partial page access reduces power consumption.

### CROSS-REFERENCE TO RELATED APPLICATIONS

The present Application for Patent claims the benefit of Provisional Patent Application No. 62/442,288 entitled “PARTIAL PAGE ACCESS IN A LOW POWER MEMORY SYSTEM” filed Jan. 4, 2017, pending, and assigned to the assignee hereof and hereby expressly incorporated herein by reference in its entirety.

### FIELD OF DISCLOSURE

Disclosed aspects are directed to processing systems. More particularly, exemplary aspects are directed to controlling memory access page size for reducing memory power consumption, based at least in part on operating frequency.

### BACKGROUND

Processing systems may include a backing storage location such as a memory subsystem comprising a main memory. For main memory implementations with large storage capacity, e.g., utilizing double-data rate (DDR) implementations of dynamic random access memory (DRAM) technology, the memory subsystem may be implemented off-chip, e.g., integrated on a memory chip which is different from a processor chip or system on chip (SoC) on which one or more processors which access the memory subsystem are integrated.

Power consumption in memory systems is a well-recognized challenge. Several techniques are known in the art for reducing power consumption in memory, such as voltage scaling. For example, the trend in voltage scaling is seen by considering the supply voltages specified in the Joint Electron Device Engineering Council (JEDEC) standard for several generations or versions of low power DDR (LPDDR). The supply voltage VDD is 1.8V for LPDDR1; 1.2V for LPDDR2 and LPDDR3; 1.1V for LPDDR4. However, for future generations (e.g., LPDDR5, and beyond) the scope for further voltage scaling is limited, because if supply voltage continues to reduce, performance degradations may be observed due to limitations imposed by refresh operations and performance of memory peripheral input/output (IO) circuitry. Thus, any power efficiency gains which may be achieved by further voltage scaling may be offset by performance and quality degradations.

Total power consumption in a memory subsystem may, among other factors, depend on how frequently rows or pages of memory banks of the memory subsystem are opened and closed. The parameter IDD0 refers to current drawn when a page of a memory bank is opened or closed, and corresponding power is the current multiplied by supply voltage. The energy consumed is proportional to the IDD0 per row cycle time (tRC). Since the current IDD0 is higher for a wider page, the IDD0 increases as the page size (or row width) of the memory bank increases. Correspondingly, power consumption increases as the page size increases. In some instances, IDD0 can consume as much as 30% of the total power budget of a multicore or multithreaded processing system.

Thus, appropriately designing page sizes for implementations of memory subsystems play an important role as the page sizes affect not only the power consumption but also the area (e.g., chip size of the memory subsystem), efficiency, flexibility in column redundancy, etc. Some memory designs favor larger page sizes as this may improve memory performance in comparison to smaller page sizes which may utilize an overall increase in the number of commands for activation and closing of the smaller pages, thus leading to performance degradation. Nevertheless, with advances in technologies, smaller page sizes are seen to be favored with a view to reducing the activation energy for each page, as reducing power consumption plays an increasingly crucial role. For example, while LPDDR3 features page sizes of 4 KB the next generation, LPDDR4 features 2 KB page sizes.

Regardless of the specific page size chosen for the design of a memory subsystem, once the architecture is fixed, the page size itself cannot be modified. In order to reconcile the conflicting requirements of lower page sizes for reducing power consumption and larger page sizes for improving performance, some known approaches (e.g., as described in U.S. Pat. No. 7,187,615) attempt to reduce power consumption by using memory access commands directed to activate partial word line segments of a page, with the premise that activating only a partial word line segment would consumes less power than activating a complete word line. However, with smaller page sizes (e.g., as seen in some mobile systems), such selective activation of partial word line segments may not be feasible as they require additional activation commands. Furthermore, even with activation of partial word line segments, power consumption associated with opening and closing the pages remains the same because the entire page is activated even for a partial word line segment access. Thus the IDD0 power consumption incurred by page activation/closing is not reduced by these approaches.

There is a corresponding need in the art for improving power efficiency of existing and future generations of memory subsystems, while overcoming the aforementioned drawbacks of conventional approaches.

### SUMMARY

Exemplary aspects of the invention include systems and methods directed to reducing power consumption of a memory based on enabling partial page access. Based on system conditions such as operating frequency, access size for one or more memory access requests are determined. The access size is programmed in a mode register of the memory and one or more commands are issued for accessing the memory based on the programmed access size. Alternatively, the access sizes are specified within the one or more commands issued to the memory for accessing partial pages. Activating only the portion of a page corresponding to the partial page access reduces power consumption.

### BRIEF DESCRIPTION OF THE DRAWINGS

The accompanying drawings are presented to aid in the description of aspects of the invention and are provided solely for illustration of the aspects and not limitation thereof.

FIG. 1 illustrates an exemplary processing system configured for partial page access according to this disclosure.

FIG. 2 illustrates an example command sequence for partial page access according to exemplary aspects of this disclosure.

FIG. 3 illustrates a flow chart pertaining to partial page access according to exemplary aspects of this disclosure.

FIGS. 4A-C illustrate command configurations for partial page access according to aspects of this disclosure.

FIG. 5 illustrates command configurations for precharging or closing partially opened page segments according to aspects of this disclosure.

FIG. 6 is a block diagram showing an exemplary wireless communication system in which aspects of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to reducing memory power consumption in a memory system. As discussed previously, current consumed in activating and closing pages of a memory bank is a significant factor in the power consumption of a memory subsystem comprising one or more memory banks. It is recognized that this current is lower if the page size is reduced. Since page sizes are difficult to reduce, as discussed above, in exemplary aspects, partial page access is enabled, whereby a page may be partially activated and closed. Activating or closing only a partial page incurs less current and consumes less power in comparison to activating or closing a full page, respectively.

In this regard, the portion of a page (i.e., a full page or a partial page portion thereof) to be targeted by a particular command may be configurable based on a desired frequency of operation (or more generally, a range of frequencies). For instance, a memory controller on a processor side or SoC of a processing system may obtain system conditions such as a frequency of operation and dynamically determine a size of a page to be accessed by commands sent from the SoC to the memory subsystem comprising memory banks. The memory subsystem may maintain a mode register to indicate the current size of page access, e.g., a full page or a partial page size. If there are changes to the operating frequency, the memory controller may update its determination of the size of page access and convey the update to the mode register. During time periods between successive mode register updates, the size of page access need not be specified. For example, once the mode register has been updated, every command which follows from the memory controller to the memory subsystem can reference the updated size of page access in the mode register. In this manner, each command does not have to carry information pertaining to the size of page access, which reduces traffic between the SoC and the memory system and thus improves performance.

In exemplary aspects, it is also recognized that the energy expended in activating a full page remains the same, even if the activation of the full page is composed of two or more partial page activations; however, the two or more partial page activations distribute the energy over time, which reduces instantaneous power, a critical component in high frequency operations. Furthermore, a series of commands may be issued for partial page activations, spread out over different segments or portions of the page wherein the different segments do not share common columns. Since sense amplifiers are only shared amongst columns but not across different segments of a page, the series of partial page accesses can proceed without closing each segment (i.e., issuing a precharge command for the segment) of the page before moving to the next segment. Thus an activate command for a next segment can be issued directly after a column command for an immediately preceding segment was issued, without impacting performance.

Furthermore, it will be understood that aspects of this disclosure may be used in conjunction with other policies which may be present for reducing power consumption, such as an open page policy wherein requests for accessing memory pages may be scheduled in such a manner that the requests are directed to pages which are already open, as this can further reduce power costs associated with activating and closing pages.

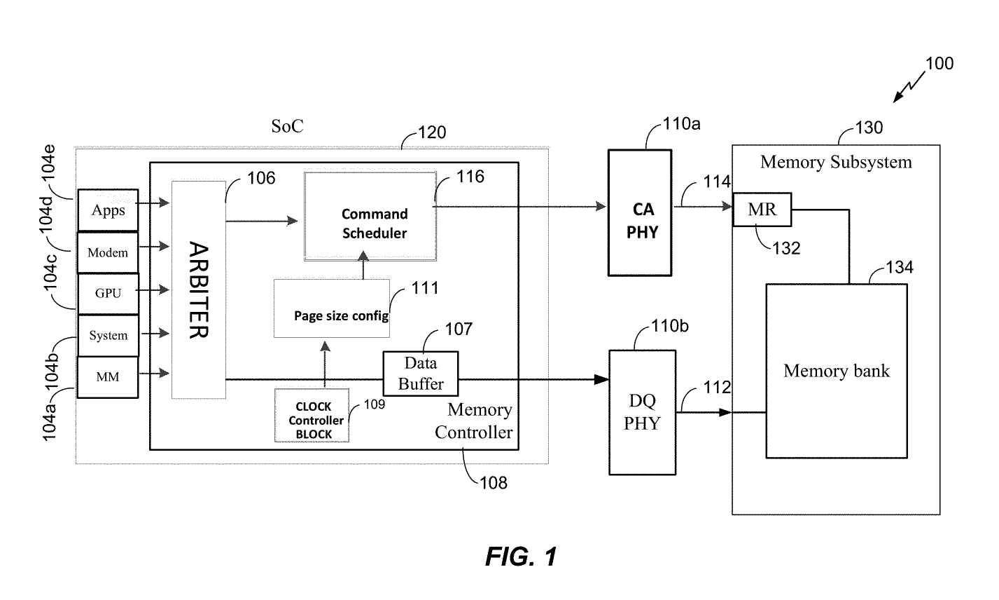

With reference now to FIG. 1, exemplary aspects of this disclosure are illustrated for processing system 100. Processing system 100 includes system on chip (SoC) 120 and memory subsystem 130. SoC 120 can comprise one or more processing elements, of which, for the sake of an exemplary illustration, processing elements 104a-e are representatively shown as multimedia (MM) processor 104a, system processor 104b, graphics processing unit (GPU) 104c, modulator-demodulator (modem) 104d, and applications processor 104e. Various other processors or processing elements such as a digital signal processor, a multi-core central processing unit (CPU), etc., may also be present even though not explicitly illustrated. Processing elements 104a-e may be connected to memory controller 108. Processing elements 104a-e may make requests for accessing one or more banks of memory in memory subsystem 130, and memory controller 108 manages and controls these access requests.

In one example, memory controller 108 may include arbiter 106 to arbitrate among the various requests received from processing elements 104a-e. Although not shown, a command queue may be included in memory controller 108 to store a number of outstanding requests. Memory controller 108 also includes data buffer 107 to store data related to the commands, e.g., write requests. Command scheduler 116 may schedule accesses to memory subsystem 130 for the requests received from arbiter 106 (or from a command queue, if present).

Additionally, memory controller 108 also includes clock controller block 109 which is configured to determine the frequency of operation of SoC 120 and generate a corresponding clock. For instance, clock controller block 109 may interact with the operating system of SoC 120 or any combination of software and hardware including processing elements 104a-e and determine, e.g., based on demands of applications being processed, a frequency of operation of memory subsystem 130. The frequency of operation of memory subsystem 130 may be increased for increasing performance if required, or decreased to save power consumption where a decreased performance is acceptable.

Memory controller 108 also includes page size configuration block 111. Page size configuration block 111 accepts the frequency of operation of memory subsystem 130 determined by clock controller block 109 as an input, and generates a corresponding size of page access. For instance, at a high frequency, to reduce power consumption, the size of page access may be reduced from a full page access to access of partial page segments. Based on the size of page access, command scheduler 116 may generate or modify commands for accessing memory subsystem 130. In an example, if the size of page access is to be modified from a previous value, command scheduler 116 may send out a command to memory subsystem 130, via physical layer module for commands shown as CA PHY block 110a, to update mode register (MR) 132 in memory subsystem 130.

Corresponding to the commands, data to be transferred for some requests (e.g., write data for write commands) may also be queued, e.g., in data buffer 107, and subsequently provided to a physical layer module for data, e.g., DQ PHY block 110b. Data received from memory subsystem 130 (e.g., read data), via DQ PHY block 110b may also be placed in the same or a different data buffer before being provided to a requesting processing element 104a-e. Various other control logic and functional blocks may be present in memory controller 108 and more generally, SoC 120, but these are not germane to this disclosure, and as such are not dealt with in further detail herein.

Two buses are shown for transferring commands and data between SoC 120 and memory subsystem 130—command bus (also referred to as CA) 114 for transferring addresses, commands, etc. from SoC 120 to memory subsystem 130 and data bus (also referred to as DQ) 112, which may be a bidirectional bus for transferring write data from SoC 120 to memory subsystem 130 and receiving read data at SoC 120 from memory subsystem 130.

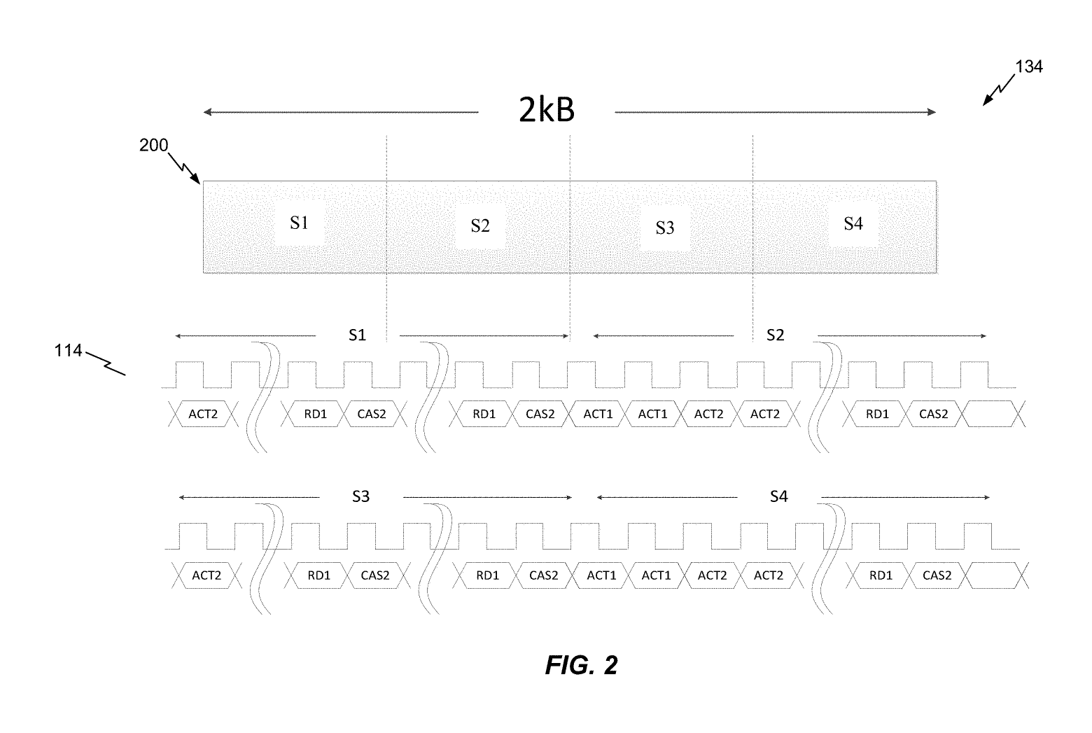

Although various details of memory subsystem 130 have been omitted from FIG. 1 for the sake of clarity, memory bank 134 is representatively shown (which can include more than one memory bank), in communication with mode register 132. In various implementations, the communication with mode register 132 may be through a decoder or latch. Memory bank 134 may include memory pages whose access may be controlled based on the size of page access received via mode register 132. Each row or page (which may be 2 KB, for example) may comprise a plurality of data segments (e.g., of 32 or 64 bytes for X16 LP4 memories, spanning a corresponding number of columns). A write command, for example received via CA 114 may include, among other components, a command address (e.g., a 6-bit command address CA [5:0]), which is decoded by a command address decoder (not shown) in memory subsystem 130 to provide a column address. Based on the column address, specific columns to be activated for a targeted data segment may be selectively activated, for example, according to the command sequence shown in FIG. 2 and discussed below.

Referring to FIG. 2, an example 2 KB page 200 of an example memory bank 134 is illustrated. Page 200 is composed of four segments shown as S1-S4, one-fourth the size of a full page such as page 200. With combined reference to FIG. 1, at a particular instance, clock controller block 109 may determine a particular operating frequency for SoC 120, based on which page size configuration block 111 may determine that a size of page access for individual commands for accessing pages of memory subsystem 130 may be set to one-fourth the size of a full 2 KB page. Correspondingly, command scheduler 116 may send a command to memory subsystem 130 to update mode register 132 to indicate that subsequent commands will be directed to data segments which are one-fourth the size of a full 2 KB page.

As shown in FIG. 2, a series of access commands may be sent on CA bus 114 directed to a first segment S1, and immediately after, a series of access commands directed to a second segment S2 may be sent on CA bus 114, without requiring the first segment S1 to be closed (e.g., a precharge command to place the first segment S1 in a native precharge mode when no access is performed). This is possible because, as previously mentioned, each one of the four segments S1-S4 has non-overlapping sets of sense amplifiers and read/write circuitry, and unless a different row or page in the same column as the first segment S1 is accessed next, the first segment S1 need not be closed. Accordingly, the exemplary techniques described herein can lead to a reduction of peak power in comparison to activation of the entire page in a single instance because by activating the four different segments S1-S4 at corresponding four different time instances, the power is distributed over the four time instances. Moreover, in contrast to the above exemplary aspects, if full page 200 is accessed instead of a single segment, e.g., S1-S4, then following the access of the full page, the full page needs to be closed, incurring a precharge command for closing the full page, before another page can be accessed. Thus, as shown, multiple read commands (RD1 followed by CAS2) can be issued for segment S1, and immediately after, a series of activate (ACT1/ACT2) commands may be issued for segment S2 without having to issue a precharge command to first close segment S1.

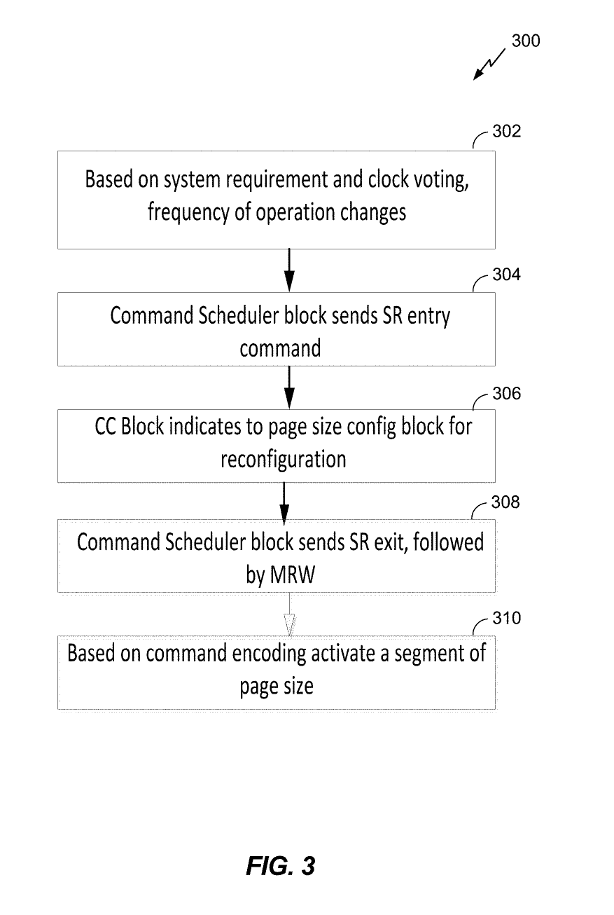

Accordingly, the exemplary aspects are seen to include various methods for performing the processes, functions and/or algorithms disclosed herein. For example, as shown in method 300 of FIG. 3, an example process for partial page activation is illustrated.

Starting with Step 302, system requirements of SoC 120, in conjunction with clock voting techniques may be employed by clock controller block 109 to establish a desired frequency of operation for SoC 120. In Step 304, command scheduler 116 may issue interim commands such as to direct memory subsystem 130 (or specific pages of memory banks 134 thereof) to enter a self-refresh (SR) mode.

In Step 306, page size configuration block 111 determines a size of page access which would be best suited for the frequency of operation established by clock controller block 109 in Step 302. Additionally, in some aspects, SoC 120 may be configured to determine power and/or performance modes (e.g., based on classifications such as low, medium, high power/performance, etc.) and based on these modes, implement frequency switches to meet the desired metrics for the modes. Accordingly, SoC 120 may write mode registers such as mode register 132 with information related to the configuration of memory subsystem 130, e.g., corresponding DRAM parameters like RL/WL etc., to support the power/performance modes. Configuration of mode registers in this regard may be in addition to the remaining mode register configurations discussed herein.

In Step 308, command scheduler 116 may receive the size of page access and issue a command to exit the self-refresh (SR) mode established for memory subsystem 130 in Step 304, followed by a command to update mode register 132 with the new size of page access.

In Step 310, once mode register 132 has been updated, future commands sent by command scheduler 116 may be for the updated size of page access (e.g., one-fourth of a 2 KB page size for accessing one of segments S1-S4) while avoiding full page activation of page 200, where possible, and thus saving on IDD0 and related power consumption.

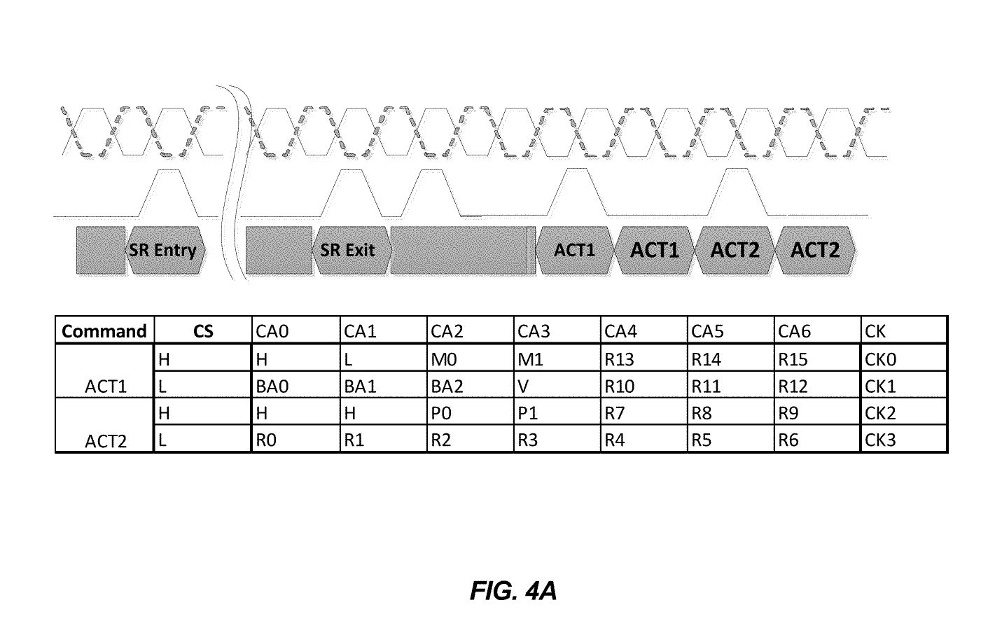

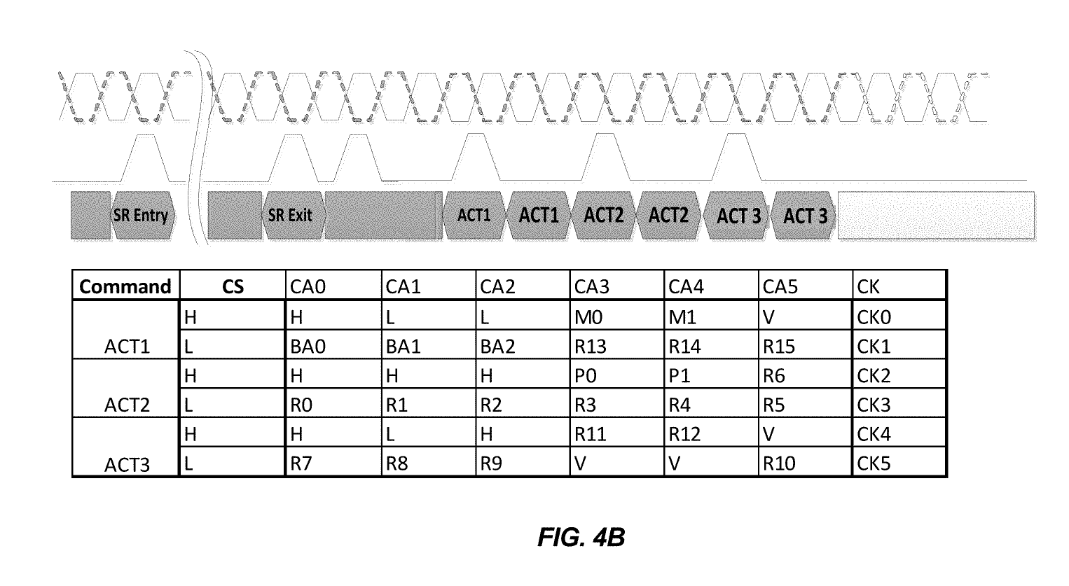

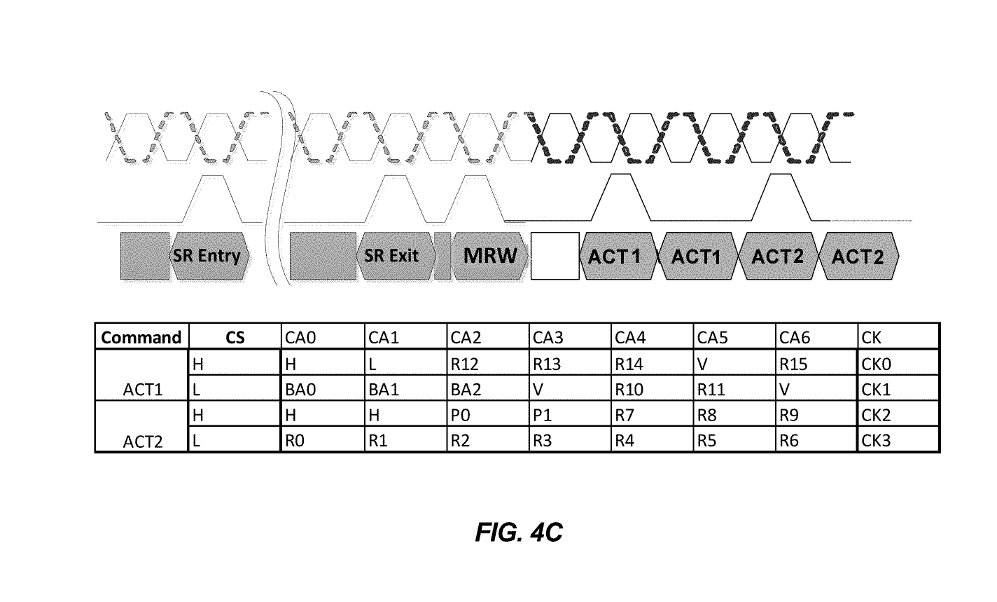

With reference now to FIGS. 4A-C, exemplary settings, e.g., command configurations, which may be used for implementing aspects of this disclosure will be discussed. For instance FIG. 4A shows a possible command sequence which may be sent on CA bus 114 for influencing partial page accesses in a DRAM implementation of memory subsystem 130 without the use of mode register programming. Thus, in this case, following the SR entry and SR exit sequences of Steps 304 and 308 of FIG. 3 above, bank activate commands may be sent in the form of two sub commands, Bank Activate 1 (ACT1) and Bank Activate 2 (ACT2) in a 4-tick sequence which conveys that the commands are for partial page accesses. Specifically, column addresses are sent on bits CA[6:0] on a rising edge of one clock while bank and row addresses are sent on the rising edge of a complementary clock. Using the column addresses, e.g., with CA[3] set to high or valid on ACT1, a size of page access is conveyed to be one-fourth of a full page, and so the column address commands are used to activate segments of one-fourth of a page size, e.g., segments S1-S4, in each of the 4-tick Bank Activate command sequence.

FIG. 4B shows another example of using the command sequence itself to access partial page segments, i.e., without the use of a mode register programming. In this case, a 6-tick or 6 cycle Bank Activate command sequence is shown with three sub-commands, Bank Activate 1 (ACT1), Bank Activate 2 (ACT2), and Bank Activate 3 (ACTS). In FIG. 4B, bits M0 and M1 can be used to decode the number of segments for activation, e.g., a value of “00” for (M1, M0) can indicate a full page, “01” can indicate 2 segments, “10” can indicate 4 segments, etc. Bits P0 and P1 may be used by memory subsystem 130 to decode which segment is addressed by the corresponding activate command, e.g. a value of “01” for (P1, P0) can indicate the second segment S2, “10” can indicate the third segment S3, etc. This manner of decoding information using the above-referenced bits such as M0, M1, P0, P1, etc., can be extended to any number of segments, e.g., 8 segments in some implementation. Any other reserved bits may also be used for encoding the above information.

In FIG. 4C, another example command sequence is shown which employs the mode register programming, e.g., setting mode register 132 (MRW) in Step 308 to establish the size of page access. In the implementation of FIG. 4C, mode register programming is performed to set mode register 132 results in configuring the number of segments for partial page access. Therefore only the bits P0 and P1 may be used for conveying the information to memory subsystem 130 regarding which particular segment is addressed by all subsequent commands which follow in this configuration.

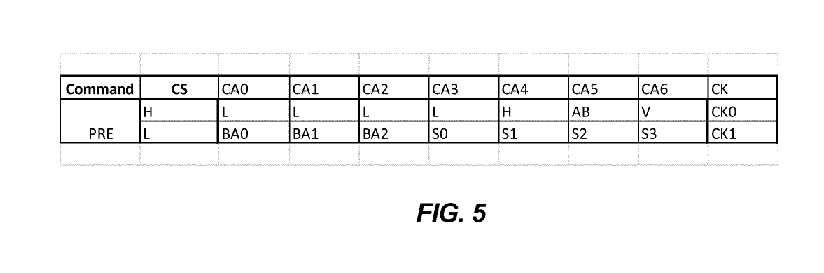

With reference now to FIG. 5, aspects pertaining to closing the partially opened page segments (e.g., according to FIGS. 4A-C) will now be discussed. As previously mentioned with reference to FIG. 2, a precharge operation is performed when a bank is closed. The precharge operation involves transferring data back from sense amplifiers to the corresponding DRAM cells which were accessed during an access operation. In the case of partial page accesses, it is possible that sense amplifiers corresponding to the partial page segments which were opened may have unintended data remaining in them, e.g., data from a different row which shares the sense amplifiers. If at the time of precharge, this unintended data is written back to the recently opened partial page segments, then the DRAM cells of the recently opened partial page segments may get corrupted. In order to prevent such unintentional corruption of DRAM cells following partial page accesses, command configurations for precharge operations following partial page accesses may be modified. FIG. 5 shows an example command configuration which may be compatible with memory subsystem 130 configured for partial page accesses.

In FIG. 5, an example is shown wherein two segments of a page, segments S1 and S2 (see FIG. 2) can remain open following a sequence of partial page accesses to these segments (e.g., as discussed in FIGS. 4A-C). In order to ensure that only the opened segments S1 and S2 are affected by an ensuing precharge command (and not segments S0 and S3, for example, as that may lead to corruption), command scheduler 116 of memory controller 108 (shown in FIG. 1) may be configured to issue precharge commands for segments S1 and S2 by setting their precharge command values to high (H) while leaving precharge commands for segments S0 and S3 unmodified. This will ensure that only the data from sense amplifiers corresponding to segments S1 and S2 will be written back or pushed into the cell arrays for DRAM cells in segments S1 and S2, while not similarly pushing back data from sense amplifiers in segments S0 and S3. Of course, the illustration in FIG. 5 and the above example command configuration is only one example and is not meant as a limitation. In various other possibilities within the scope of this disclosure, selective precharge commands may be provided to any one or more previously opened partial page segments while ensuring that precharge is not signaled for unmodified segments such that unintentional corruption may be avoided for partial page segments which were not recently opened for access.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for managing memory accesses, including partial page memory accesses, in a processing system. Accordingly, the invention is not limited to illustrated examples and any means for performing the functionality described herein are included in aspects of the invention.

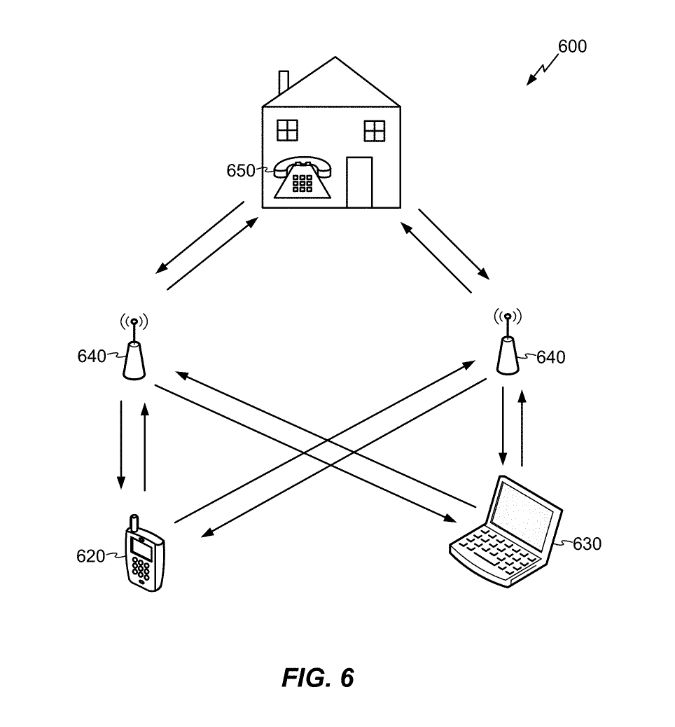

FIG. 6 illustrates an exemplary wireless communication system 600 in which an aspect of the disclosure may be advantageously employed. For purposes of illustration, FIG. 6 shows three remote units 620, 630, and 650 and two base stations 640. In FIG. 6, remote unit 620 is shown as a mobile telephone, remote unit 630 is shown as a portable computer, and remote unit 650 is shown as a fixed location remote unit in a wireless local loop system. For example, the remote units may be integrated into a set top box, a server, a music player, a video player, an entertainment unit, a navigation device, a personal digital assistant (PDA), a fixed location data unit, a computer, a laptop, a tablet, a communications device, a mobile phone, or other similar devices. Although FIG. 6 illustrates remote units according to the teachings of the disclosure, the disclosure is not limited to these exemplary illustrated units. Aspects of the disclosure may be suitably employed in any device which includes active integrated circuitry including memory and on-chip circuitry for test and characterization.

The foregoing disclosed devices and methods are typically designed and are configured into GDSII and GERBER computer files, stored on a computer-readable media. These files are in turn provided to fabrication handlers who fabricate devices based on these files. The resulting products are semiconductor wafers that are then cut into semiconductor die and packaged into a semiconductor chip. The chips are then employed in devices described above.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of accessing a memory by a processing system, the method comprising:
determining an access size for accessing a memory bank of a memory; and
if the access size corresponds to a partial page, providing one or more commands for activating only partial page segments of the memory bank to service access requests to the memory.

2. The method of claim 1, comprising determining the access size based on a frequency of operation of the processing system.

3. The method of claim 2, comprising setting the access size in a mode register associated with the memory, and updating the mode register when there is a change in the frequency.

4. The method of claim 3, further comprising sending one or more commands for accessing one or more partial pages of the memory, based on the access size set in the mode register, wherein the one or more commands for accessing do not specify the access size.

5. The method of claim 2, comprising reducing the access size for an increase in the frequency of operation.

6. The method of claim 1, comprising specifying the access size in one or more commands for accessing partial page segments.

7. The method of claim 1, further comprising providing one or more commands for selectively precharging only a partial page segment of a page which was activated, while avoiding precharging remaining segments of the page which were not activated.

8. The method of claim 1, further comprising providing a series of one or more consecutive commands for selectively activating one or more partial page segments which do not share a common column.

9. The method of claim 8, wherein the series of one or more consecutive commands do not include commands for closing the one or more partial page segments which are selectively activated.

10. An apparatus comprising:
a processing system comprising a memory controller configured to manage accesses to a memory, wherein the memory controller comprises:
a page size configuration block configured to determine an access size for a memory bank of a memory; and
a command scheduler configured to provide one or more commands for activation of only partial page segments of the memory bank to service access requests to the memory, if the access size corresponds to a partial page.

11. The apparatus of claim 10, wherein the memory controller further comprises a clock controller configured to determine the access size based on a frequency of operation of the processing system.

12. The apparatus of claim 11, wherein the command scheduler is further configured to provide a command to set the access size in a mode register associated with the memory.

13. The apparatus of claim 12, wherein the command scheduler is further configured to provide a command to update the mode register when there is a change in the frequency determined by the clock controller.

14. The apparatus of claim 13, wherein the command scheduler is further configured to send one or more commands to access one or more partial pages of the memory, based on the access size set in the mode register, wherein the one or more commands do not specify the access size.

15. The apparatus of claim 11, wherein the clock controller is configured to reduce the access size if there is an increase in the frequency of operation.

16. The apparatus of claim 10, wherein the command scheduler is further configured to specify the access size in one or more commands to access partial page segments.

17. The apparatus of claim 10, wherein the command scheduler is further configured to provide one or more commands to selectively precharge only a partial page segment of a page which was activated, without precharge operations applied to remaining segments of the page which were not activated.

18. The apparatus of claim 10, wherein the command scheduler is further configured to provide a series of one or more consecutive commands to selectively activate one or more partial page segments which do not share a common column.

19. The apparatus of claim 18, wherein the series of one or more consecutive commands do not include commands to close the one or more partial page segments which are selectively activated.

20. The apparatus of claim 10, wherein the memory comprises a dynamic random access memory (DRAM).

21. The apparatus of claim 10, integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

22. An apparatus comprising:
means for determining an access size for accessing a memory bank of a memory by a processing system; and
means for providing one or more commands for activating only partial page segments of the memory bank to service access requests to the memory, if the access size corresponds to a partial page.

23. The apparatus of claim 22 comprising means for determining the access size based on a frequency of operation of the processing system.

24. The apparatus of claim 22, comprising means for setting the access size in a means for storing a mode, associated with the memory.

25. The apparatus of claim 23, further comprising means for updating the means for storing the mode when there is a change in the frequency.

26. The apparatus of claim 25, further comprising means for sending one or more commands for accessing one or more partial pages of the memory, based on the access size set in a mode register, wherein the one or more commands for accessing do not specify the access size.

27. The apparatus of claim 22, comprising means for reducing the access size for an increase in the frequency of operation.

28. The apparatus of claim 22, comprising means for specifying the access size in one or more commands for accessing partial page segments.

29. A method of managing memory access, the method comprising:
receiving, at a memory, one or more commands from a processing system, the one or more commands directed to access of one or more partial page segments of a memory bank of the memory; and
selectively activating only the one or more partial page segments of the memory bank to service the one or more commands.

30. The method of claim 29, comprising receiving an access size for the one or more partial page segments and storing the access size in a mode register associated with the memory.
